(19) United States
(12) Patent Application Publication
(10) Pub. No.: US 2019/0360260 A1
(43) Pub. Date: Nov. 28, 2019

(54) SCREEN DOOR KIT FOR PATIO SLIDING GLASS DOORS THAT SWING OUT

(71) Applicant: Ben Hunter, Moreno Valley, CA (US)

(72) Inventor: Ben Hunter, Moreno Valley, CA (US)

(21) Appl. No.: 16/422,960

(22) Filed: May 25, 2019

Related U.S. Application Data
(60) Provisional application No. 62/676,961, filed on May 26, 2018.

(51) Int. Cl. E06B 3/50; E06B 9/52; E06B 3/46

(52) U.S. Cl. CPC E06B 3/5081; E06B 9/52; E05Y 2900/136; E06B 2009/527; E06B 3/46

(57) ABSTRACT

A screen door kit for patio sliding glass doors that swing out structured and arranged to replace the sliding screen doors associated with sliding glass patio doors with a traditional, hinged screen door that is sold as an easy-to-install kit thereby eliminating the problems of sliding screen doors, which tend to come off their tracks or get stuck.

### CROSS-REFERENCE TO RELATED APPLICATION

The present application is related to and claims priority from prior provisional application Ser. No. 62/676,961, filed May 26, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of screen doors and more specifically relates to a screen door kit for patio sliding glass doors that swing out structured and arranged to replace the sliding screen doors associated with sliding glass patio doors with a traditional, hinged screen door that is sold as an easy-to-install kit thereby eliminating the problems of sliding screen doors, which tend to come off their tracks or get stuck.

### 2. DESCRIPTION OF THE RELATED ART

Consider, for example, that whether we live in the city, the suburbs, or the country, almost all of us like to enjoy a living space that offers us some access to the outdoors. Houses typically include a porch or patio for this purpose, while apartments and condos—even high-rises—generally provide their occupants with a balcony or terrace. On the balcony, patio or terrace, we can enjoy our morning coffee or the night air; take in the view of sky, buildings, landscape and lights; find fresh air and privacy in the midst of the city or the suburbs; even enjoy the pleasures of cooking-out or maintaining a flower or vegetable garden.

Most such patios, porches, and balconies feature a sliding-glass door, and these doors in turn feature sliding screens that move horizontally in channels. Unfortunately, the screens tend to get stuck in their channels or come out of them, creating the problem of freeing them up or getting them back in. Also, because the screens are virtually invisible, they're all too easy to walk into—or through; and if you've got your hands full, pulling and pushing that screen in order to open and close it is near to impossible. These sliding screens, clearly, cause a lot of problems and frustrations—problems and frustrations that the invention to be presented and explored in the course of this report would neatly eliminate, much to the appreciation of millions of householders.

Various attempts have been made to solve problems found in screen doors art. Among these are found in: U.S. Pat. No. 3,291,192 to Harold D. Jones Jr; U.S. Pat. No. 4,478,267 to Raymond E. Smiley; and U.S. Pat. No. 4,838,332 to Patrick L. Mlenek. This prior art is representative of screen doors for patio sliding glass doors that swing out.

Ideally, a screen door kit for patio sliding glass doors that swing out should be user-friendly and safe in-use and yet would operate reliably and be manufactured at a modest expense. Thus, a need exists for a screen door kit for patio sliding glass doors that swing out structured and arranged to replace the sliding screen doors associated with sliding glass patio doors with a traditional, hinged screen door that is sold as an easy-to-install kit thereby eliminating the problems of sliding screen doors, which tend to come off their tracks or get stuck and to avoid the above-mentioned problems.

### BRIEF SUMMARY OF THE INVENTION

In view of the foregoing disadvantages inherent in the known screen doors art, the present invention provides a novel Screen Door Kit for Patio Sliding Glass Doors That Swing Out. The general purpose of the present invention, which will be described subsequently in greater detail is to provide a screen door kit for patio sliding glass doors that swing out structured and arranged to replace the sliding screen doors associated with sliding glass patio doors with a traditional, hinged screen door that is sold as an easy-to-install kit thereby eliminating the problems of sliding screen doors, which tend to come off their tracks or get stuck.

A screen door kit for patio sliding glass doors that swing out, the screen door kit comprising: a converter strip comprising a milled piece of trim, and wherein the converter strip includes at least two hinge mounts and at least two screw mounts; a casing anchor comprising a milled piece of trim; and a screen door with an inside side and an outside side. Wherein the converter strip is mountable on a user's existing sliding glass door frame.

The screen door includes: at least one screen portion; an outer frame, wherein the outer frame comprises a material selected from the group consisting of wood, vinyl, and aluminum; at least two hinges, wherein the hinges are attachable to the hinge mounts of the converter; a handle located on the inside side; a handle located on the outside side; a center cross-brace; and a hydraulic door closer. Wherein the casing anchor is ninety-three inches in height, wherein the converter strip is ninety-four inches in height, and wherein the screen door is ninety-four inches in height and thirty-six and one half inches in width.

The present invention holds significant improvements and serves as a Screen Door Kit for Patio Sliding Glass Doors That Swing Out. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Screen Door Kit for Patio Sliding Glass Doors That Swing Out Entitled constructed and operative according to the teachings of the present invention.

FIG. 1 shows a perspective view illustrating a Screen Door Kit for Patio Sliding. Glass Doors That Swing Out according to an embodiment of the present invention.

FIG. 2 is a perspective view illustrating a Screen Door Kit for Patio Sliding Glass Doors That Swing Out according to an embodiment of the present invention of FIG. 1.

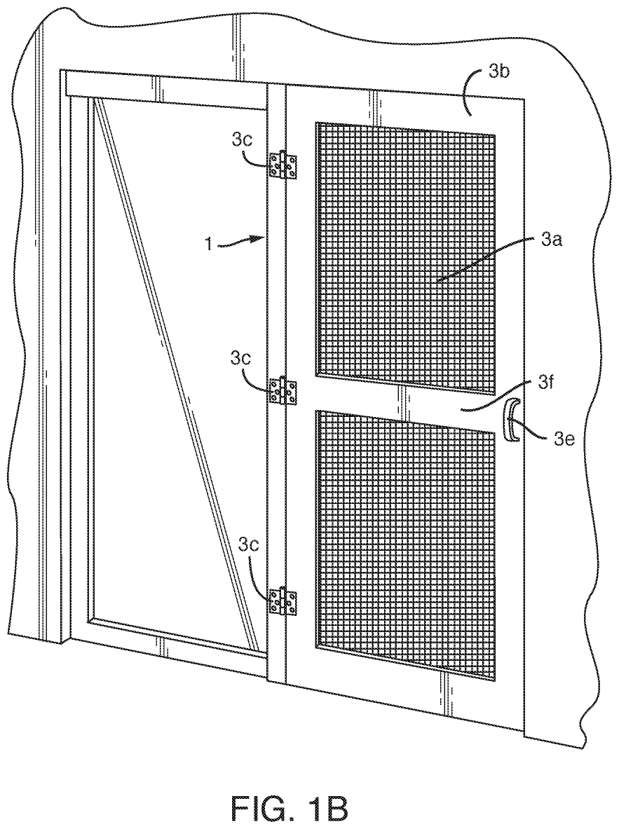

FIG. 3 is a perspective view illustrating Screen Door Kit for Patio Sliding Glass Doors That Swing Out according to an embodiment of the present invention of FIG. 1.

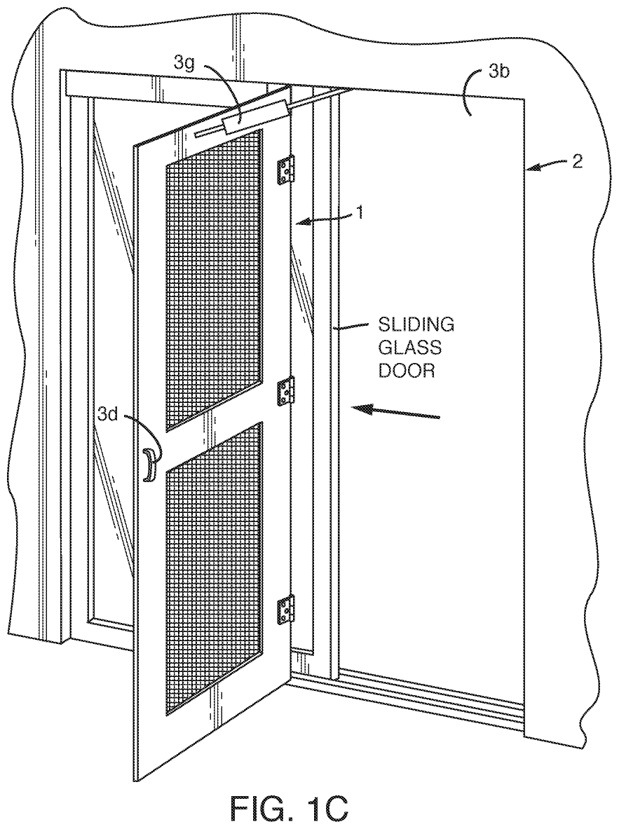

The various embodiments of the present invention will hereinafter be described in conjunction with the appended drawings, wherein like designations denote like elements.

### DETAILED DESCRIPTION

As discussed above, embodiments of the present invention relate to a screen door and more particularly to a Screen Door Kit for Patio Sliding Glass Doors That Swing Out structured and arranged to replace the sliding screen doors associated with sliding glass patio doors with a traditional, hinged screen door that is sold as an easy-to-install kit thereby eliminating the problems of sliding screen doors, which tend to come off their tracks or get stuck.

Generally speaking, the Screen Door Kit for Patio Sliding Glass Doors That Swing Out comprising a novel product offering consumers a practical solution to the aforementioned challenges. As the name implies, the Screen Door Kit for Patio Sliding Glass Doors That Swing Out would offer consumers with sliding-glass patio, porch, or balcony doors the best of both worlds: the plate-glass patio door which they've come to enjoy, with a traditional, self-closing, hinged screen door that will keep the bugs out of the house, condo, or apartment, while making it easy to move—even with both arms full—between the inside and outside.

The Screen Door Kit for Patio Sliding Glass Doors That Swing Out would offer consumers with sliding-glass patio, porch, or balcony door the best of both worlds. The sliding plate-glass patio door which they've come to enjoy, with a traditional, self-closing, hinged screen door that replaces the existing sliding screen door. The Screen Door Kit for Patio Sliding Glass Doors That Swing Out would be a complete, easy to install kit, suitable for installation as either a retrofit to replace a sliding screen, or for installation in newly constructed homes. The door itself would measure 94 inches in height by 36½ inches in width, with a center cross-brace and a handle on either side.

The Revolutionary Patio Screen Door would be fabricated in wood, although a vinyl or aluminum clad screen door would also be an option. The hinge-side “jamb” of the Revolutionary Patio Screen Door would consist of two additional milled pieces of trim, which would be screwed into the end of the existing glass door frame. One of these pieces, the “casing anchor,” measures 93 inches in height; the other, the “converter board,” measures 94 inches in height. Together, these form the jamb of the Revolutionary Patio Screen Door, and the fastening base for the screen door's hinges. The Screen Door Kit for Patio Sliding Glass Doors That Swing Out includes a hydraulic door closer, to provide a smooth, even closure and eliminate slamming.

The Revolutionary Patio Screen Door is a vast improvement over the sliding screens which sliding glass doors are now equipped, and should find a wide and enthusiastic reception in the home improvement and new-construction markets.

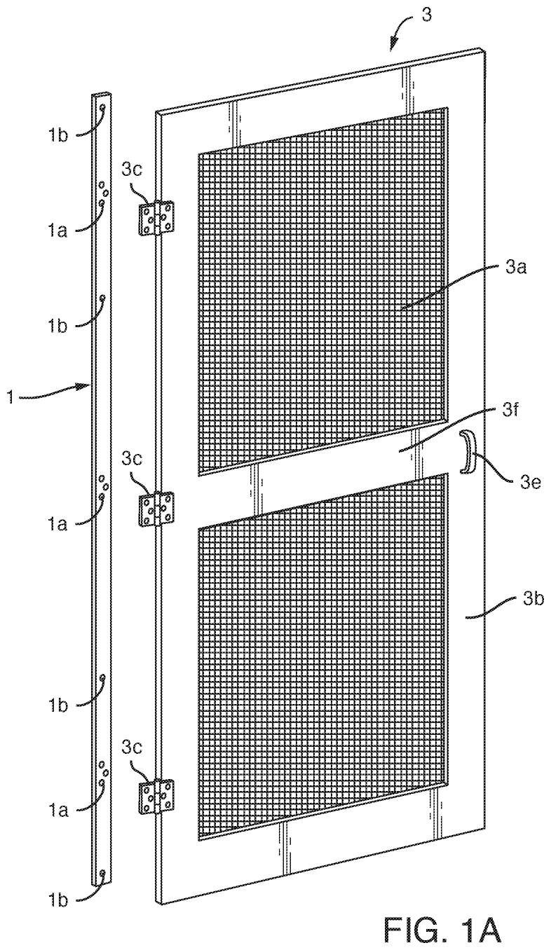

Referring to the drawings by numerals of reference there is shown in FIGS. 1A-1C illustrating, perspective views illustrating a screen door kit for patio sliding glass doors that swing out according to an embodiment of the present invention.

A screen door kit for patio sliding glass doors that swing out, the screen door kit comprising: converter strip 1 comprising a milled piece of trim, and wherein the converter strip including at least two hinge mounts 1a, and at least two screw mounts 1b; casing anchor 2 comprising a milled piece of trim; and a screen door 3 with an inside side and an outside side. Wherein converter strip 1 is mountable on a user's existing sliding glass door frame.

Wherein casing anchor 2 is ninety-three inches in height, wherein converter strip 1 is ninety-four inches in height, and wherein the screen door is ninety-four inches in height and thirty-six and one half inches in width.

Screen door 3 includes at least one screen portion 3a; outer frame 3b, wherein the outer frame comprises a material selected from the group consisting of wood, vinyl, and aluminum; at least two hinges 3c, wherein the hinges are attachable to the hinge mounts of the converter; handle 3d located on the inside side; handle 3e located on the outside side; center cross-brace 3f; and hydraulic door closer 3g.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A screen door kit for patio sliding glass doors that swing out, the screen door kit comprising:
(1) a converter strip, wherein the converter strip includes
(a) hinge mounts, and
(b) screw mounts, and
wherein the converter strip is mountable on a user's existing sliding glass door frame;
(2) a casing anchor;
(3) a screen door with an inside side and an outside side, wherein the screen door includes
(a) at least one screen portion,
(b) an outer frame,
(c) at least two hinges, wherein the hinges are attachable to the hinge mounts of the converter.

2. The screen door kit according to claim 1, wherein the screen door further comprises:
(d) a handle located on the inside side, and
(e) a handle located on the outside side.

3. The screen door kit according to claim 1, wherein the screen door further comprises:
(d) a hydraulic door closer.

4. The screen door kit according to claim 1, the outer frame comprises a material selected from the group consisting of wood, vinyl, and aluminum.

5. The screen door kit according to claim 1, wherein the casing anchor and the converter strip are wood.

6. The screen door kit according to claim 5, wherein the converter strip comprises a milled piece of trim, and wherein the casing anchor comprises a milled piece of trim.

7. The screen door kit according to claim 1, wherein the casing anchor is ninety-three inches in height, wherein the converter strip is ninety-four inches in height, and wherein the screen door is ninety-four inches in height and thirty-six and one half inches in width.

8. The screen door kit according to claim 1, wherein the screen door further comprises:
(d) a center cross-brace.

9. A screen door kit for patio sliding glass doors that swing out, the screen door kit comprising:
(1) a converter strip comprising a milled piece of trim, and wherein the converter strip includes
(a) at least two hinge mounts, and
(b) at least two screw mounts, and
wherein the converter strip is mountable on a user's existing sliding glass door frame;
(2) a casing anchor comprising a milled piece of trim;
(3) a screen door with an inside side and an outside side, wherein the screen door includes
(a) at least one screen portion,
(b) an outer frame, wherein the outer frame comprises a material selected from the group consisting of wood, vinyl, and aluminum,
(c) at least two hinges, wherein the hinges are attachable to the hinge mounts of the converter,
(d) a handle located on the inside side,
(e) a handle located on the outside side,
(f) a center cross-brace, and
(g) a hydraulic door closer.

10. The screen door kit according to claim 9, wherein the casing anchor is ninety-three inches in height, wherein the converter strip is ninety-four inches in height, and wherein the screen door is ninety-four inches in height and thirty-six and one half inches in width.
